(19) United States
(12) Patent Application Publication
(10) Pub. No.: US 2025/0220444 A1
(43) Pub. Date: Jul. 3, 2025

(54) Channel Selection in Wireless Networks for Narrowband-Assisted Ultra-Wideband Signaling

(71) Applicant: Cisco Technology, Inc., San Jose, CA (US)

(72) Inventors: Peiman Amini, Fremont, CA (US); Jerome Henry, Pittsboro, NC (US); Ardalan Alizadeh, Campbell, CA (US); Matthew Silverman, RICHARDSON, TX (US); Sivadeep R. Kalavakuru, Pleasanton, CA (US)

(21) Appl. No.: 18/917,967

(22) Filed: Oct. 16, 2024

Related U.S. Application Data
(60) Provisional application No. 63/616,434, filed on Dec. 29, 2023.

(51) Int. Cl. H04W 16/14; G01S 13/02; G01S 13/76; H04W 74/08

(52) U.S. Cl. CPC H04W 16/14; G01S 13/0209; G01S 13/765; H04W 74/08

(57) ABSTRACT

Devices, systems, methods, and processes for channel selection in wireless networks for narrowband-assisted ultra-wideband (NBA-UWB) signaling and ranging. Narrowband signal overlaps the existing ISM bands and thus has high likelihood of interfering with Wi-Fi, Bluetooth Low Energy (BLE), and other technologies used inside a network device. Therefore, selection of an appropriate target channel that may be used for UWB signaling can mitigate interference with Wi-Fi/BLE signals. A network device may receive one or more channel status messages from a plurality of neighboring network devices. The channel status messages may indicate a channel associated with a respective neighboring network device and a channel metric associated with the channel. The channel metric may indicate channel quality, traffic status, signal strength, etc. Based on a set of available channels indicated by the one or more channel status messages, the network device may select a target channel to execute a UWB signaling.

This application claims the benefit of U.S. Provisional Patent Application No. 63/616,434, filed Dec. 29, 2023, which is incorporated by reference herein in its entirety.

The present disclosure relates to communication networks. More particularly, the present disclosure relates to channel selection in wireless networks for narrowband-assisted Ultra-Wideband (UWB) signaling.

### BACKGROUND

Dense Wi-Fi networks, especially for enterprise operations, install various Access Points (APs), for example, one for every 2,000-6,000 square feet. With ever-increasing requirements for applications such as indoor positioning, location-based services, or the like, precise determination of accurate indoor location has become important. APs usually take support of Ultra-Wideband (UWB) technology for accurate location determination, which transmits signals over a very wide frequency range which is typically greater than 500 MHz. UWB is usually preferred for short-range, high-precision location tracking applications due to its ability to operate with low power and high accuracy. However, the range of UWB is much less than Wi-Fi, thus, most network deployments need additional anchors to have ubiquitous UWB coverage throughout the floors.

One method to mitigate the above issue is to utilize the signaling information of the UWB frame to increase UWB range. The signaling information is part of preamble and Physical Layer Header (PHR) of the UWB frame and is utilized for synchronization, timing, and informing the receiving device about how to interpret the upcoming data. The UWB signaling can be utilized by using an additional narrow band channel in Industrial, Scientific, and Medical (ISM) band which allows for additional transmit power or power spectral density (PSD) for UWB. Some of the mechanisms in 802.15.4ab (NBA—Narrow Band Assisted UWB ranging) may be utilized. However, the narrow band signal lies in the existing ISM bands, and can be prone to interference with Wi-Fi, Bluetooth Low Energy (BLE), or other co-existing technologies in the AP.

### SUMMARY OF THE DISCLOSURE

Systems and methods for channel selection in wireless networks for narrowband-assisted Ultra-Wideband (UWB) signaling in accordance with embodiments of the disclosure are described herein. In some embodiments, a network device includes a processor, and a memory communicatively coupled to the processor, wherein the memory includes a channel selection logic that is configured to receive one or more channel status messages. A channel status message of the one or more channel status messages may be configured to indicate a channel associated with a neighboring device of the network device and a channel metric associated with the channel; select, from a set of available channels, a target channel based on the one or more channel status messages, and execute a ranging round by utilizing the selected target channel.

In some embodiments, to select the target channel, the channel selection logic is further configured to identify, based on the one or more channel status messages, a channel associated with a lowest channel metric among the set of available channels, and wherein the channel associated with the lowest channel metric is selected as the target channel.

In some embodiments, the selected target channel is commonly utilized by the network device and the neighboring device to execute corresponding ranging rounds.

In some embodiments, the target channel utilized by the network device to execute the ranging round is different from a channel utilized by the neighboring device to execute one or more ranging rounds.

In some embodiments, an interference exhibited by the selected target channel in one or more Wi-Fi operations of the network device and the neighboring device is less than a threshold value.

In some embodiments, the channel metric corresponds to a Received Signal Strength Indicator (RSSI) value determined by the neighboring device on the channel for a source device.

In some embodiments, the source device corresponds to one of the network device or another neighboring device.

In some embodiments, the channel status message is further configured to indicate a first identifier associated with the neighboring device and a second identifier associated with the source device.

In some embodiments, to select the target channel, the channel selection logic is further configured to determine, based on the one or more channel status messages, that one or more neighboring devices of the network device are utilizing a plurality of non-overlapping channels, and select, as the target channel, at least one intermediate channel between two adjacent non-overlapping channels of the plurality of non-overlapping channels.

In some embodiments, the ranging round corresponds to a Narrowband-Assisted Ultra-Wideband (NBA-UWB) ranging round.

In some embodiments, to execute the NBA-UWB ranging round, the channel selection logic is further configured to execute, based on the selected target channel, a Narrowband (NB) signaling that transmits a data packet via an NB signal, wherein the data packet is configured to indicate a time period for reception of a plurality of fragments, and execute, based on an Ultra-Wideband (UWB), a UWB signaling that transmits at least one fragment of the plurality of fragments via a UWB signal.

In some embodiments, a first communication interface is configured to operate on one or more channels of the set of available channels, and a second communication interface configured to operate on the UWB.

In some embodiments, the network device corresponds to a wireless access point.

In some embodiments, the neighboring device corresponds to another wireless access point deployed within a communication range of the network device.

In some embodiments, a channel selection logic is configured to receive a plurality of channel status messages, wherein a channel status message of the plurality of channel status messages is configured to indicate a channel associated with one of the plurality of access points and a channel metric associated with the channel, select, from a set of available channels, a target channel based on the plurality of channel status messages, and control at least one access point of the plurality of access points to execute a ranging round by utilizing the selected target channel.

In some embodiments, the channel metric is configured to indicate one or more of a Received Signal Strength Indicator (RSSI) value associated with the channel, a scheduled amount of traffic associated with the channel, or an amount of traffic buffered to at least one priority queue of the channel.

In some embodiments, the channel selection logic is further configured to select, as the target channel, one of a channel associated with a lowest RSSI value among the set of available channels, a channel associated with a lowest scheduled amount of traffic among the set of available channels, or a channel associated with a lowest amount of traffic buffered to at least one priority queue among the set of available channels.

In some embodiments, to select the target channel, the channel selection logic is further configured to control, based on the plurality of channel status messages, an access point of the plurality of access points to transmit a null data frame for a specific time duration on a specific channel among the set of available channels, and wherein the specific channel is selected as the target channel for the specific time duration.

In some embodiments, the network device corresponds to a Wireless Network Controller.

In some embodiments, a method includes receiving one or more channel status messages, wherein a channel status message of the one or more channel status messages is configured to indicate a channel associated with a neighboring device of a network device and a channel metric associated with the channel, selecting, from a set of available channels, a target channel based on the one or more channel status messages, and executing a ranging round by utilizing the selected target channel.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration depicting Wi-Fi and Ultra-Wideband (UWB) coexistence in accordance with various embodiments of the disclosure;

FIG. 2 is a conceptual diagram illustrating an NB Signaling and a UWB Signaling between an initiator device and a responder device in accordance with various embodiments of the disclosure;

FIG. 3 is a conceptual diagram illustrating an intermediate channel between adjacent non-overlapping channels being utilized as a target channel for NB-Assisted UWB ranging in a Wi-Fi coexistence scenario in accordance with various embodiments of the disclosure;

FIG. 4 is a conceptual diagram illustrating WLC coordinated ranging in accordance with various embodiments of the disclosure;

FIG. 5 is a flowchart showing a process for channel selection by a network device for executing NB-Assisted UWB ranging rounds in accordance with various embodiments of the disclosure;

FIG. 6 is a flowchart showing a process for channel selection for ranging measurements in accordance with various embodiments of the disclosure;

FIG. 7 is a flowchart showing a process using a wireless controller for channel selection used for ranging in accordance with various embodiments of the disclosure;

FIG. 8 is a flowchart showing a process for channel selection by a wireless controller for NB-Assisted UWB ranging in accordance with various embodiments of the disclosure;

FIG. 9 is a flowchart showing a process for NB-Assisted UWB ranging in a BLE coexistence scenario in accordance with various embodiments of the disclosure; and

FIG. 10 is a conceptual block diagram for one or more devices capable of executing components and logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that provide interference management for coexisting Access Points (APs) and Ultra-wideband (UWB) technology used for precise location determination in communication networks. UWB is a radio technology that utilizes very low energy levels for short-range, high-bandwidth communications over a large portion of the radio spectrum. Typically, UWB technology is used for precise indoor location tracking leveraging highly accurate time-based measurements like Time of Flight (ToF) and Time Difference of Arrival (TDoA). In dense Wi-Fi networks, such as enterprise networks, multiple APs are deployed to provide complete Wi-Fi coverage, for example, one for every 2,000-6,000 square feet. With new-age applications requiring precise location tracking, indoor navigation, proximity, and access control and UWB range being much shorter than Wi-Fi, most communication networks require additional anchors to have ubiquitous UWB coverage.

To increase the UWB range, one solution involves utilizing an additional narrow band channel in Industrial, Scientific, and Medical (ISM) band, as part of UWB frame signaling. This allows for additional transmit power or Power Spectral Density (PSD) for UWB. For example, the 802.15.4ab standard describes Narrow Band Assisted (NBA) UWB ranging, which refers to a hybrid approach that combines the characteristics of both narrowband and UWB signals to improve the performance and robustness of ranging and location tracking in wireless networks. 802.15.4ab standard (amendment to 802.15.4) that defines specifications for low-data rate, low power wireless communications, and specifically focuses on enhancing and adapting the standard for UWB communication, specifically for precise ranging and location tracking applications. In NBA UWB ranging, narrowband signals are utilized to send advertisement packets containing timing information for upcoming UWB ranging rounds. These advertisement packets help the transmit and the receive devices synchronize, provide an initial discovery mechanism, and control of UWB channel. After the initial NB advertisement, transmit and receive devices switch to UWB for actual ranging measurements. However, the NB signal lies on the existing ISM bands and thus, may be prone to interference with Wi-Fi, Bluetooth Low Energy (BLE), or other technologies being used in the AP.

To address the above issues, the present disclosure provides a solution for the coexistence of narrowband UWB (NB-UWB) signal with Wi-Fi, BLE, or other wireless technologies utilized in access points. In many embodiments, in Wi-Fi network deployment, such as dense Wi-Fi networks utilized in enterprise operations, APs of the network maintain a neighbor list and corresponding channels of each AP in the network, as part of network management and optimization functions. The neighbor list may include information such as AP Media Access Control (MAC) Addresses, load information, signal strength, service set identifier (SSID) of each AP, channel information, or the like. The APs may exchange such neighbor list through distribution system (DS) as explained in Inter-Access Point Protocol (IAPP) defined by IEEE 802.11F utilized by APs to communicate with each other or can be measured through Over-the-air (OTA scans).

In numerous embodiments, the APs may exchange channel status messages, each configured to indicate a channel associated with a current AP and a channel metric. The channel metric may indicate information regarding the quality and condition of the channel. For example, the channel metric may include information such as a Received Signal Strength Indicator (RSSI) value of the channel, interference levels, channel load, or other such information. In a variety of embodiments, the APs may exchange the channel status messages with a central management platform (such as a Wireless Local Area Network Controller “WLC”). Based on the information indicated by received channel status messages, an AP or the central management platform may select a target channel from a set of available channels.

In a number of embodiments, the selected target channel may be utilized for a ranging round with a neighboring device. In further embodiments, the current AP may transmit a narrowband signaling (NB) to the neighboring device. The NB signaling may be utilized to indicate a time period for reception of a plurality of fragments during a UWB ranging round. In yet more embodiments, the current AP may utilize the time period indicated by the NB signaling to execute the UWB ranging with the neighboring device. Thus, the selection of the target channel based on information indicated by the channel status messages may provide interference management for UWB ranging with other coexisting wireless technologies.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

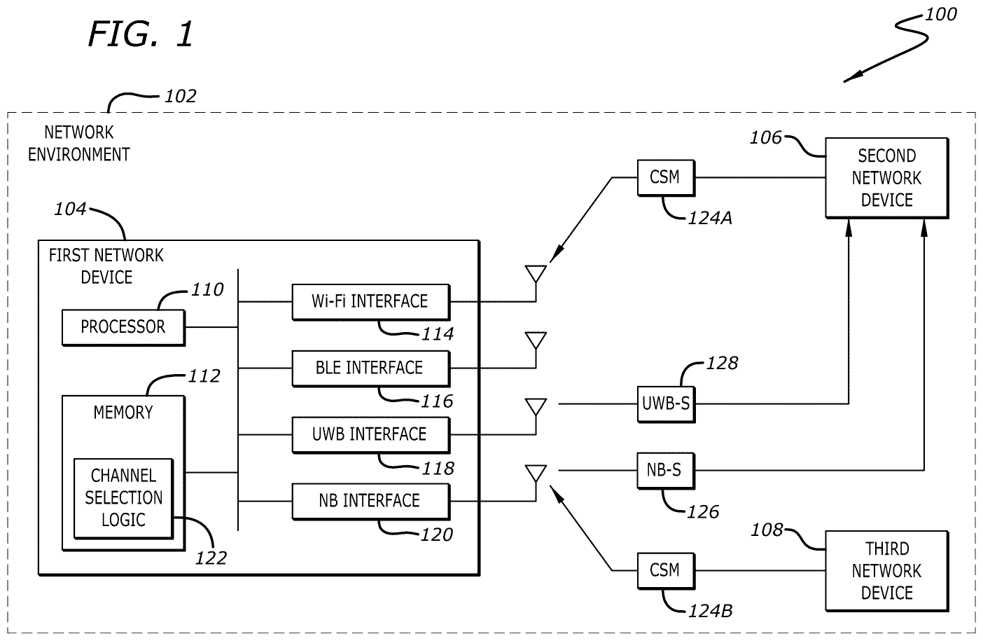

Referring to FIG. 1, a conceptual illustration 100 depicting Wi-Fi and Ultra-Wideband (UWB) coexistence in accordance with various embodiments of the disclosure is shown. The embodiment shown in FIG. 1 may depict a network environment 102 with a plurality of network devices such as a first network device 104, a second network device 106, and a third network device 108. Examples of the plurality of network devices may include access points (APs), routers, switches, firewalls, gateway, or the like. In an example scenario, the network environment 102 may refer to an enterprise network having the plurality of network devices to provide seamless network coverage. In many embodiments, the first network device 104 may include a processor 110, a memory 112, various network interfaces such as a Wi-Fi interface 114, a Bluetooth Low Energy (BLE) interface 116, a UWB interface 118, and a Narrowband (NB) interface 120, among other internal components. In a similar manner, the second network device 106 and the third network device 108 may also be equipped with processors, memory, network interfaces, or the like having similar functionality as respective components of the network device 104.

In a number of embodiments, the processor 110 may be implemented as one or more microprocessors, microcomputers, microcontrollers, digital signal processors, central processing units, logic circuitries, and/or any devices that process data based on operational instructions. Among other capabilities, the processor 110 may be configured to fetch and execute computer-readable instructions stored in the memory 112. Further examples of the processor 110 may include Application-Specific Integrated Circuit (ASIC) processors, Reduced Instruction Set Computing (RISC) processors, Complex Instruction Set Computing (CISC) processors, Field-Programmable Gate Arrays (FPGAs), Digital Signal Processor (DSPs), or the like.

In variety of embodiments, the memory 112 may be coupled to the processor 110. The memory 112 may be configured to store one or more computer-readable instructions or routines in a non-transitory computer-readable storage medium, which may be fetched and executed by the processor 110. The memory 112 may include any non-transitory storage device including, for example, volatile memory such as random-access memory (RAM), a read-only memory (ROM), or non-volatile memory such as EPROM, a hard disk drive (HDD), a flash memory, a solid-state memory, and the like. It will be apparent to a person skilled in the art that the scope of the disclosure is not limited to realizing the memory 112 in the plurality of network devices 104, 106, and 108, as described herein. In several embodiments, the memory 112 may be realized in the form of a database server or a cloud storage working in conjunction with the plurality of network devices 104, 106, and 108 without departing from the scope of the disclosure.

In more embodiments, each of the network interfaces (for example, the Wi-Fi interface 114, the BLE interface 116, the UWB interface 118, and the NB interface 120) may include suitable logic, circuitry, interfaces, and/or code, executable by the circuitry, which may be configured to perform one or more operations associated with transmitting and receiving data/signals. Other examples of the network interfaces may include, but are not limited to, antennae, radio frequency transceivers, Zigbee transceivers, software-defined radios, or any other device configured to transmit and receive data.

In additional embodiments, the memory 112 may store a channel selection logic 122. The channel selection logic 122 may include instructions, such as a set of codes, to execute a channel selection process for selecting a target channel to be utilized by a network device for ranging rounds. In many further embodiments, the channel selection logic 122 may select a target channel to be commonly utilized by a network device and a neighboring device to execute corresponding ranging rounds. The channel selection logic 122 may select the target channel based on information indicated by channel status messages (CSMs) received from one or more network devices operational in the network environment 102. In an example scenario, the first network device 104 may receive a plurality of CSMs 124A, 124B from the second network device 106 and the third network device 108. In many further embodiments, a CSM may be configured to indicate a first identifier associated with a neighboring device and a second identifier associated with a source device of the CSM. The CSM may further indicate a channel associated with the neighboring device (for example, a peer AP) and a channel metric associated with the channel. The channel metric associated with the channel may include information regarding quality and condition of the channel, such as a Received Signal Strength Indicator (RSSI) value, signal-to-noise ratio (SNR), interference levels, channel load, or other such information. In additional embodiments, the channel metric may correspond to a RSSI value determined by a neighboring device on the channel for a source device. The source device, in many additional embodiments, may correspond to one of the network device or another neighboring device. In an example, the CSM 124A received by the first network device 104 from the second network device 106 may use a format to indicate a first identifier of a peer AP such as the first network device 104, a second identifier of the second network device 106 which is the source of the CSM 124A, a channel, and an Received Signal Strength Indicator (RSSI) value on the channel. Likewise, the CSM 124B received by the first network device 104 from the third network device 108 may use a format to indicate an identifier of a peer AP, a third identifier of the third network device 108 which is the source of the CSM 124B, a channel, and an RSSI value on the channel. Depending upon a number of peer APs, the first network device 104 may receive multiple CSMs from the same neighboring devices. For example, in the network environment 102 where each network device has two neighboring devices, the first network device 104 can receive two CSMs from each of the second network device 106 and two CSMs from the third network device 108, one for each corresponding neighboring devices. Format of each CSM can be {source AP identifier; neighboring AP identifier; channel; channel metric} or {neighboring AP identifier; source AP identifier; channel; channel metric} based on the network configuration. Similarly, the second network device 106 and the third network device 108 may also receive one or more CSMs from neighboring devices.

In still more embodiments, the channel selection logic 122 may utilize the CSM 124A, 124B information to determine a set of available channels from among all the channels being utilized by the network devices in the network environment 102. The channel selection logic 122 may thus, select a target channel, from the set of available channels, based on the CSMs 124A, 124B. In still further embodiments, the channel selection logic 122 may select the target channel having the lowest channel metric among the set of available channels as per the CSM 124A, 124B. For example, the channel selection logic 122 may select the channel having the lowest RSSI value from among the set of available channels, as the target channel. In numerous embodiments, the channel selection logic 122 may select the target channel such that the interference exhibited by the selected target channel in one or more Wi-Fi operations of the first network device 104 and the second network device 106 may be less than a threshold value. In numerous additional embodiments, the channel selection logic 122 may select a channel that has a maximum distance to all neighboring APs.

In still further embodiments, the channel selection logic 122 may utilize the selected target channel for ranging rounds with a neighboring device, for example, a network device, a mobile client device, or any other device capable of NB-UWB ranging for ranging measurements. In the example scenario continued from above, the channel selection logic 122 may perform a ranging round with the second network device 106 by utilizing the selected target channel. To perform the ranging round, the first network device 104 may transmit a narrowband signaling (NB-S) 126 to the second network device 106. The NB-S 126 may be utilized to transmit a data packet via a narrowband (NB) signal to coordinate and synchronize between the first network device 104 and the second network device 106. The NB-S 126 data packet may be configured to indicate a time period for reception of a plurality of fragments during the ranging round. Further, the first network device 104 may utilize the time period indicated by the NB signal data packet to execute the UWB ranging with the second network device 106 by using UWB signaling (UWB-S) 128. The UWB-S 128 may include at least one fragment of the plurality of fragments as a UWB signal pulse to perform Time-of-flight (ToF) measurements. In numerous embodiments, the target channel selected by the channel selection logic 122 of the first network device 104 to execute the ranging round can be commonly utilized by the second network device 106 and the third network device 108 for executing corresponding ranging rounds. In numerous embodiments, the first network device 104 may utilize a first communication interface (such as the Wi-Fi interface 114) to operate on one or more channels of the set of available channels, and a second communication interface (such as a UWB interface 118) configured to operate on the UWB to execute the ranging round.

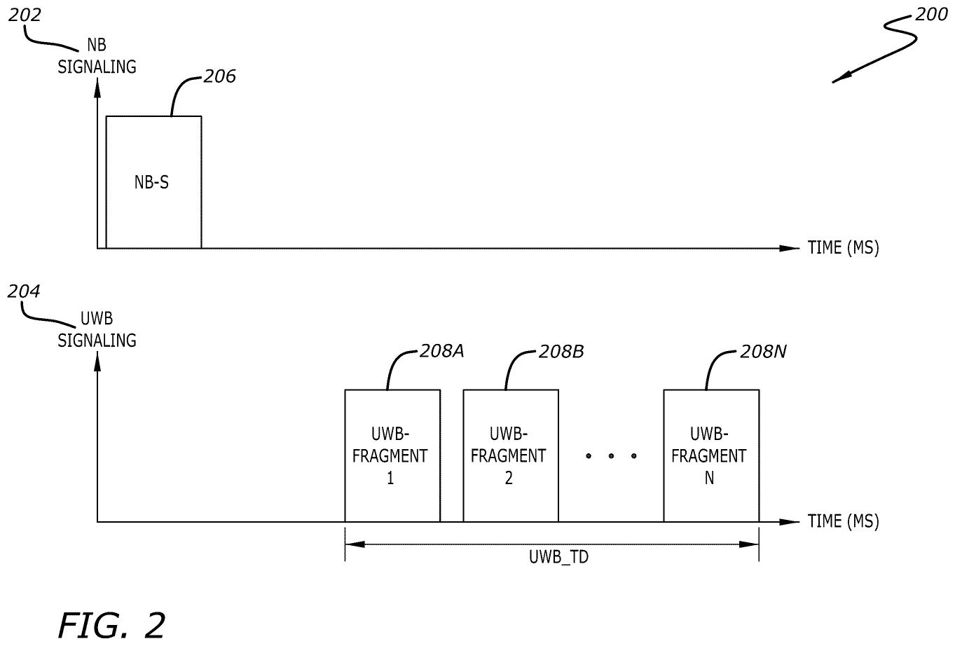

Although a specific embodiment depicting Wi-Fi and UWB coexistence suitable for carrying out the various steps, processes, methods, and operations described herein is discussed with respect to FIG. 1, any of a variety of systems and/or processes may be utilized in accordance with embodiments of the disclosure. In several embodiments, the target channel selected by the channel selection logic 122 of the first network device 104 to execute the ranging round may be different from a target channel selected by the second network device 106 to execute one or more ranging rounds. The elements depicted in FIG. 1 may also be interchangeable with other elements of FIGS. 2-10 as required to realize a particularly desired embodiment.

Referring to FIG. 2, a conceptual diagram 200 illustrating an NB Signaling and a UWB Signaling between an initiator device and a responder device in accordance with various embodiments of the disclosure is shown. The embodiments depicted in the conceptual diagram 200 may depict a timing sequence of NB Signaling 202 and UWB Signaling 204 as utilized during a ranging round between the initiator device and the responder device. In an example scenario comprising an enterprise network, the initiator device may correspond to a first access point and the responder device may be a peer access point or any mobile device roaming within the enterprise network.

In many embodiments, once the initiator device has selected a target channel for executing a ranging round, the initiator device may execute the NB Signaling 202 that transmits an NB-S data packet 206. The NB-S data packet 206 may be utilized to coordinate and synchronize between the initiator device and the responder device. The NB-S data packet 206 may be configured to indicate a time period for reception of a plurality of fragments, by the responder device, during the ranging round. For example, the NB-S data packet 206 can indicate a time window or interval (UWB_TD) when the UWB Signaling 204 pulses or burst would be transmitted or expected. This may help minimize errors due to clock drift or desynchronization between the initiator device and the responder device.

In a number of embodiments, the initiator device, after transmitting the NB-S data packet 206, may execute the UWB Signaling 204 in the form of a plurality of UWB fragments, for example, a UWB-Fragment 1 208A, a UWB-Fragment 2 208B, . . . , a UWB-Fragment N 208N. Each of the plurality of UWB fragments may depict a UWB signal pulse or burst. The plurality of UWB fragments may be very short and precise pulses of radio energy. In a variety of embodiments, the initiator device may transmit the plurality of UWB Fragments to the responder device over the time interval UWB_TD, as indicated by the NB-S data packet 206. The responder device may respond by sending one or more UWB signals back to the initiator device in response to the plurality of UWB Fragments. Thus, the initiator device may determine the ToF for the plurality of UWB Fragments based on a round-trip time of the UWB signal and estimate the distance between the initiator device and the responder device.

Although a specific embodiment depicting an NB Signaling and a UWB Signaling between an initiator device and a responder device suitable for carrying out the various steps, processes, methods, and operations described herein is discussed with respect to FIG. 2, any of a variety of systems and/or processes may be utilized in accordance with embodiments of the disclosure. In many additional embodiments, when operating in Multi-Millisecond (MMS) mode of the UWB ranging, the NB Signaling 202 may be disabled. The elements depicted in FIG. 2 may also be interchangeable with other elements of FIGS. 1 and 3-10 as required to realize a particularly desired embodiment.

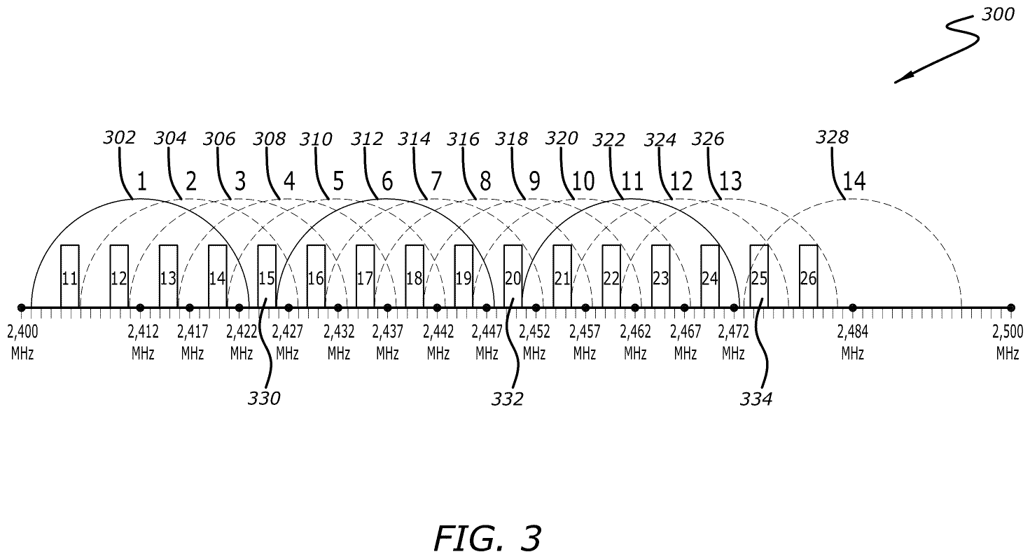

Referring to FIG. 3, a conceptual diagram 300 illustrating an intermediate channel between adjacent non-overlapping channels being utilized as a target channel for NB-Assisted UWB ranging in a Wi-Fi coexistence scenario in accordance with various embodiments of the disclosure is shown. The embodiments depicted in the conceptual diagram 300 may depict a plurality of non-overlapping channels of Wi-Fi 2.4 GHz band. As shown in FIG. 3, the Wi-Fi 2.4 GHz band is divided into 14 channels (channels 1-14), represented by numerals 302, 304, 306, . . . , 328. In an example, each of the channels 1-14 may be 22 MHz wide.

The 2.4 GHz band can be divided into multiple overlapping channels. As can be seen in FIG. 3, channel 1, which is shown to be centered at 2.412 GHz, overlaps with channels 2, 3, and 4 (designated as numerals 304, 306, and 308, respectively). This overlap of channels may cause Wi-Fi devices on adjacent channels to cause interference with each other, thus, reducing performance. In order to minimize the interference, a plurality of non-overlapping channels are utilized in 2.4 GHz band. For example, as shown in FIG. 3, three non-overlapping channels 1, 6, and 11 (designated as numerals 302, 312, and 322, respectively) can be utilized for Wi-Fi communication. These channels are spaced apart so that they do not overlap, thus, minimizing interference between Wi-Fi devices operating on these three non-overlapping channels. In many embodiments, the Wi-Fi 2.4 GHz band may have coexisting narrowband (NB) channels, (channels 11-26). In a variety of embodiments, if all the non-overlapping channels (such as channels 1, 6, and 11 in the 2.4 GHz band) may have ongoing transmission or scheduled traffic, an intermediate channel (for example, any of the channels 15, 20, or 25, designated respectively as numerals 330, 332, and 334) may be selected as a target channel for NB-Assisted UWB ranging. The intermediate channel may lie between two adjacent non-overlapping channels of the plurality of non-overlapping channels.

In a variety of embodiments, the target channel may be selected by a network device based on various channel status messages received by the network device from peer network devices in the network. Each channel status message may be configured to indicate a channel and a channel metric associated with the channel. Thus, when the received channel status messages indicate the utilization of the plurality of non-overlapping channels by the peer network devices with ongoing transmission or scheduled traffic, the network device may select the intermediate channel between two adjacent non-overlapping channels of the plurality of non-overlapping channels as the target channel for NB-Assisted UWB signaling.

Although a specific embodiment depicting an intermediate channel between adjacent non-overlapping channels being utilized as a target channel for NB-Assisted UWB ranging in a Wi-Fi coexistence scenario suitable for carrying out the various steps, processes, methods, and operations described herein is discussed with respect to FIG. 3, any of a variety of systems and/or processes may be utilized in accordance with embodiments of the disclosure. In further additional embodiments, a network device may select the target channel from among the 3 BLE advertisement channels (channels 37, 38, and 39 in the 2.4 GHz band). The elements depicted in FIG. 3 may also be interchangeable with other elements of FIGS. 1-2 and 4-10 as required to realize a particularly desired embodiment.

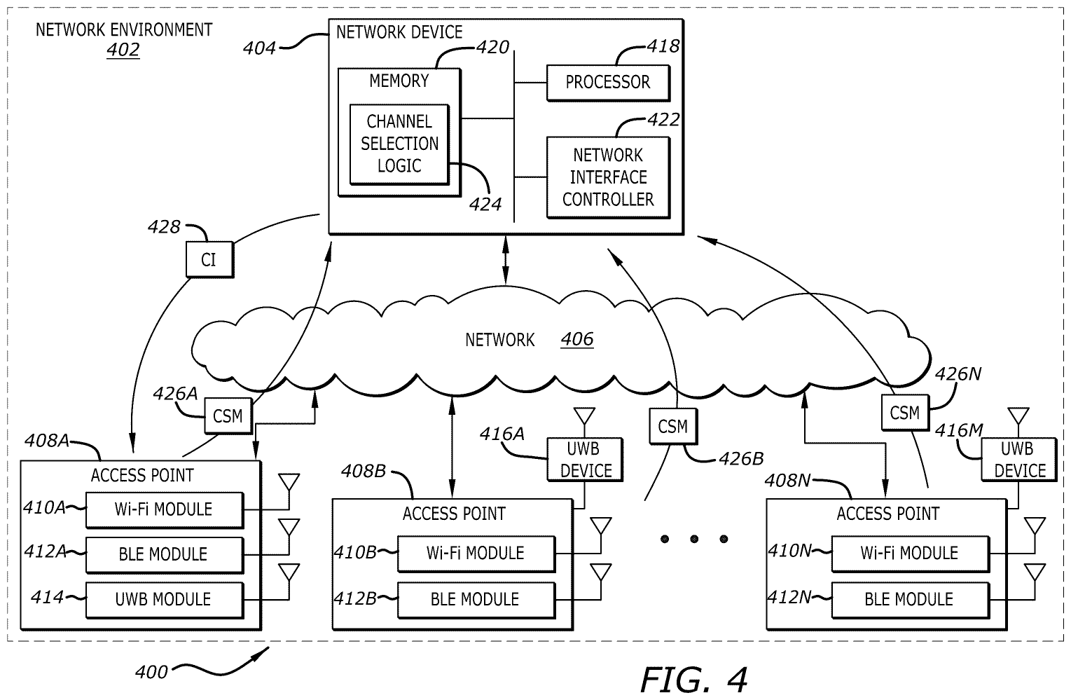

Referring to FIG. 4, a conceptual diagram 400 illustrating WLC coordinated ranging in accordance with various embodiments of the disclosure is shown. The embodiments depicted in the conceptual diagram 400 may depict a network environment 402 controlled and managed by a network device 404. Examples of the network device 404 may include a wireless controller (WLC), wireless network controller (WNC), wireless management system, or the like. The network device 404 may be configured to manage, control, and optimize multiple wireless access points (APs) within the network environment 402 (such as enterprise environments, large campuses, or the like).

In additional embodiments, the network device 404 may be connected, through a network 406, to one or more APs 408A, 408B, . . . , 408N (hereinafter, collectively referred to as “the APs 408A-N”). The network 406 can include any suitable wired networks or wireless networks. In further embodiments, the APs 408A-N may include Wi-Fi modules 410A, 410B, . . . , 410N, respectively, and BLE modules 412A, 412B, . . . , 412N, respectively. In still more embodiments, the AP 408A may also include a UWB module 414. In still further embodiments, the APs 408B, . . . , 408N may include external UWB devices 416A, . . . , 416M, respectively. The UWB devices 416A, . . . , 416M may be externally coupled to the APs 408B, . . . , 408N, respectively, to provide UWB coverage in case the APs 408B, . . . , 408N do not have inbuilt UWB capability or have limited UWB range.

In many embodiments, the network device 404 may include a processor 418, a memory 420, a network interface controller 422, and other internal components. In a number of embodiments, the processor 418 may be implemented as one or more microprocessors, microcomputers, microcontrollers, digital signal processors, central processing units, logic circuitries, and/or any devices that process data based on operational instructions. Among other capabilities, the processor 418 may be configured to fetch and execute computer-readable instructions stored in the memory 420. Further examples of the processor 418 may include an ASIC processor, a RISC processor, a CISC processor, an FPGA, a DSPs, or the like.

In variety of embodiments, the memory 420 may be coupled to the processor 418. The memory 420 may be configured to store one or more computer-readable instructions or routines in a non-transitory computer-readable storage medium, which may be fetched and executed by the processor 418. The memory 420 may include any non-transitory storage device including, for example, volatile memory such as RAM, a ROM, or non-volatile memory such as EPROM, an HDD, a flash memory, a solid-state memory, and the like. It will be apparent to a person skilled in the art that the scope of the disclosure is not limited to realizing the memory 420 in the network device 404, as described herein. In several embodiments, the memory 420 may be realized in the form of a database server or a cloud storage working in conjunction with the network device 404 without departing from the scope of the disclosure.

In more embodiments, the network interface controller 422 may include suitable logic, circuitry, interfaces, and/or code, executable by the circuitry, which may be configured to perform one or more operations associated with transmitting and receiving data/signals. Examples of the network interface controller may include, but are not limited to, antennae, radio frequency transceivers, wireless transceivers, Bluetooth transceivers, Zigbee transceivers, software-defined radios, or any other device configured to transmit and receive data.

In still further embodiments, the memory 420 may store a channel selection logic 424. The channel selection logic 424 may include instructions, such as a set of codes, to execute a channel selection process for selecting a target channel to be utilized by a network device (such as any of the APs 408A-N) for executing ranging rounds. In still additional embodiments, the network device 404 may receive a plurality of channel status messages (denoted as “CSMs”) 426A, 426B, . . . , 426N from the APs 408A, 408B, . . . , 408N, respectively. Each CSM 426A, 426B, . . . , 426N may be configured to indicate a channel associated with one of the APs 408A-N and a channel metric associated with the channel. The channel metric associated with the channel may include information regarding quality and condition of the channel, such as an RSSI value, an SNR, interference levels, channel load, or other such information.

In yet more embodiments, the channel selection logic 424 may select, from a set of available channels, a target channel based on the plurality of CSMs 426A, 426B, . . . , 426N, to be utilized for executing ranging rounds. In still yet more embodiments, the channel selection logic 424 may select a channel associated with the lowest RSSI value among the set of available channels as the target channel. In many further embodiments, the channel selection logic 424 may select a channel associated with the lowest scheduled amount of traffic or a channel associated with the lowest amount of traffic buffered to at least one priority queue among the set of available channels, as the target channel.

In an example scenario, considering non-overlapping channels 1, 6, and 11 in Wi-Fi 2.4 GHz band, channel 1 may have a scheduled traffic, buffered video streaming data, and web browsing data from the AP 408B, channel 6 may have buffered video streaming traffic in priority queue from the AP 408N, and channel 11 may only have non-urgent background traffic from the AP 408A. Thus, the channel selection logic 424 may select channel 11 as the target channel based on the amount of traffic on each channel.

In many additional embodiments, the network device 404 may transmit a channel indicator (CI) 428, representing the selected target channel, to one or more of the APs 408A, 408B, . . . , 408N for executing ranging rounds. In an example shown in FIG. 4, the network device 404 may transmit the CI 428, representing the selected target channel, to the APs 408A for executing ranging rounds A ranging round may be executed by the AP 408A by utilizing the selected target channel.

In numerous embodiments, the network device 404 can transmit the CI 428 to other APs 408B, . . . , 408N to allow all APs 408A, 408B, . . . , 408N in network cluster to execute the ranging rounds by utilizing the same target channel. In such scenario, the network device 404 can select a channel that has the maximum distance to the set of available channels being utilized by the APs 408A, 408B, . . . , 408N for their Wi-Fi operations, as the target channel for executing the ranging rounds. The channel that has the maximum distance to the set of available channels may cause the least interference with the ongoing or scheduled Wi-Fi operations of the APs 408A, 408B, . . . , 408N. In other words, the AP 408A and its neighboring APs 408B, . . . , 408N can commonly utilize the selected target channel indicated by the CI 428 to execute corresponding ranging rounds.

Although a specific embodiment for various environments depicting WLC coordinated ranging suitable for carrying out the various steps, processes, methods, and operations described herein is discussed with respect to FIG. 4, any of a variety of systems and/or processes may be utilized in accordance with embodiments of the disclosure. In numerous embodiments, in many non-limiting examples, the channel selection logic 424 may be provided as a device or software separate from the network device 404. The elements depicted in FIG. 4 may also be interchangeable with other elements of FIGS. 1-3 and FIGS. 5-10 as required to realize a particularly desired embodiment.

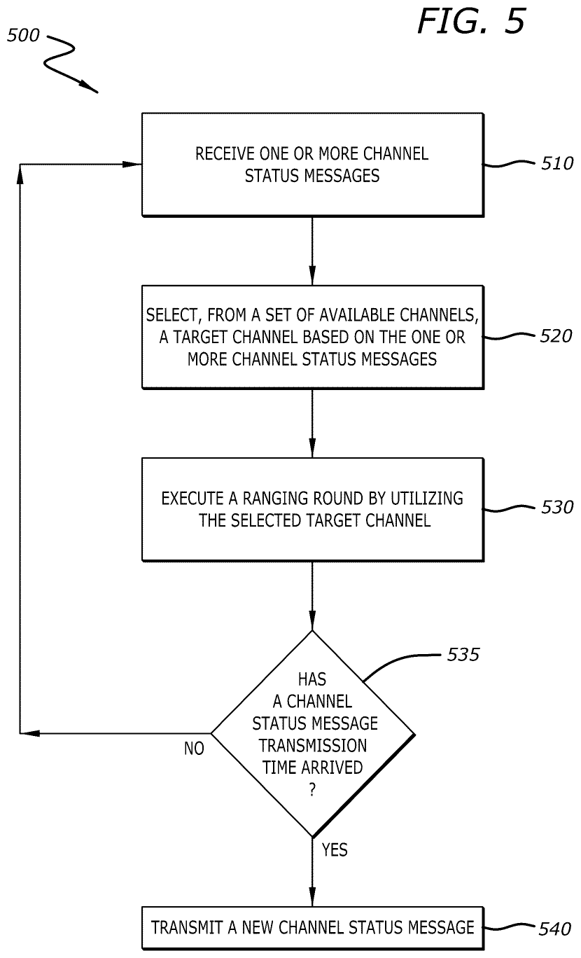

Referring to FIG. 5, a flowchart showing a process 500 for channel selection by a network device for executing NB-Assisted UWB ranging rounds in accordance with various embodiments of the disclosure is shown. In many embodiments, the process 500 may receive one or more channel status messages (block 510). The process 500 may receive one or more channel status messages from one or more neighbor network devices. In an example scenario, a network device such as an AP may receive one or more channel status messages from each of one or more nearby APs. In a variety of embodiments, each channel status message may include information such as a channel associated with a peer AP and a channel metric associated with the channel. For example, the process 500 may receive the one or more channel status messages in a format that includes a current AP identifier, a neighboring AP identifier, a channel, and a channel metric associated with the channel. In a number of embodiments, the process 500 may receive the channel metric as an RSSI value, a SNR value, interference levels, channel load, or other such information.

In more embodiments, the process 500 may select, from a set of available channels, a target channel based on the one or more channel status messages (block 520). The process 500 may receive information related to one or more neighbor APs channel utilization. In various embodiments, the process 500 may, select from the set of available channels, a channel that is associated with the lowest RSSI value among the set of available channels as the target channel. In additional embodiment, the process 500 may select a channel that is associated with the lowest scheduled amount of traffic among the set of available channels as the target channel. In an example scenario, the process 500 may select a channel that is mostly idle or has occasional background data transmissions from nearby APs. Other available channels may be engaged in high to moderate traffic load due to APs handling large data transfers, transmitting to devices such as video conferencing systems, or the like. In further embodiments, the process 500 may a channel that is associated with the lowest amount of traffic buffered to at least one priority queue among the set of available channels as the target channel. For example, the process 500 may check whether the set of available channels has any traffic buffered to at least one priority queue, such as for real-time applications like VoIP (AC_VO), for video streaming (AC_VI), or the like from the neighboring APs. Thus, the process 500 may select the channel with the lowest amount of traffic buffered to the at least one priority queue. In yet various embodiments, the set of available channels may include those channels that are available for communication to the AP and on which NB-Assisted UWB ranging can be performed.

In still more embodiments, the process 500 may execute a ranging round by utilizing the selected target channel (block 530). For example, the process 500 may execute an NB-Assisted UWB ranging round based on the selected target channel. To execute the NB-Assisted UWB ranging round, the process 500 may utilize the selected target channel to execute NB signaling that transmits a data packet via an NB signal. The NB signal data packet may be utilized to coordinate and synchronize between transmission and reception devices. In still additional embodiments, the data packet may be configured to indicate a time period for reception of a plurality of fragments during the ranging round. For example, the NB signal data packet may indicate specify a time window or interval when UWB pulses or burst should be transmitted or expected, thus, to minimize errors due to clock drift or desynchronization between the transmission and reception devices. Further, the process 500 may execute, based on an UWB, a UWB signaling that transmits at least one fragment of the plurality of fragments via a UWB signal. The at least one fragment may be transmitted in the time window or interval specified in the NB signal data packet.

In yet more embodiments, the process 500 may determine whether a channel status message transmission time has arrived (block 535). The process 500 may transmit a channel status message to other neighbor APs at regular intervals to provide information regarding quality and condition of the channel being utilized by the process 500. The process 500 may transmit the channel status message at regular intervals to ensure that the neighbor APs can maintain an updated view of the condition of the channel.

If the process 500 determines that channel status message transmission time has arrived, in still yet more embodiments, the process 500 may transmit a new channel status message (block 540). The new channel status message(s) may be transmitted to neighbouring devices. However, if it is determined that the channel status message transmission time has not yet arrived, in many further embodiments, the process 500 may continue to receive one or more channel status messages (block 510).

Although a specific embodiment depicting a process for channel selection by a network device for executing NB-Assisted UWB ranging rounds suitable for carrying out the various steps, processes, methods, and operations described herein is discussed with respect to FIG. 5, any of a variety of systems and/or processes may be utilized in accordance with embodiments of the disclosure. For example, in several embodiments, the channel status message may include management frames such as beacon frames, probe responses, or the like. The elements depicted in FIG. 5 may also be interchangeable with other elements of FIGS. 1-4 and 6-10 as required to realize a particularly desired embodiment.

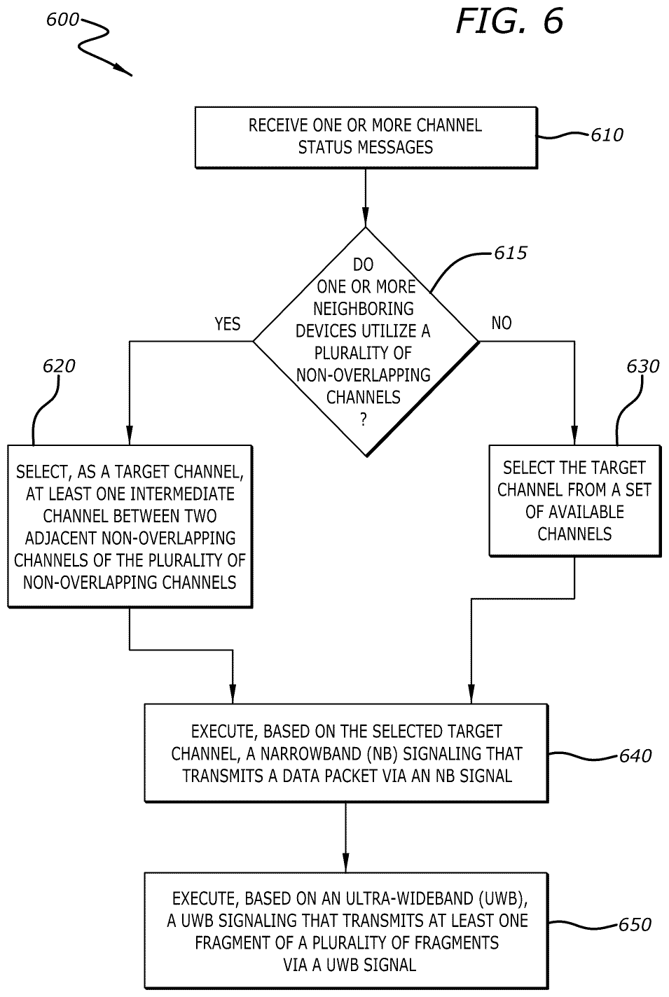

Referring to FIG. 6, a flowchart showing a process 600 for channel selection for ranging measurements in accordance with various embodiments of the disclosure is shown. In many embodiments, the process 600 may receive one or more channel status messages (block 610). The process 600 may receive the one or more channel status messages from one or more neighbor network devices, such as one or more nearby APs. The channel status messages may include information such as interference levels, signal strength, noise, and channel utilization. In a variety of embodiments, each channel status message may include a channel identifier of a channel and a channel metric associated with the channel. The channel metric may provide information about the quality and conditions of the channel, such as an RSSI vale, interference levels, noise, channel utilization, or the like.

In a number of embodiments, the process 600 may determine whether one or more neighboring devices utilize a plurality of non-overlapping channels (block 615). The process 600 may determine, based on the one or more channel status messages, whether the one or more neighboring devices (e.g., nearby APs) utilize non-overlapping channels for their communication operations. For example, Wi-Fi network devices may utilize non-overlapping channels 1, 6, and 11 in the 2.4 GHz band to avoid interference.

If the one or more neighboring devices utilize a plurality of non-overlapping channels, in a variety of embodiments, the process 600 may select, as a target channel, at least one intermediate channel between two adjacent non-overlapping channels of the plurality of non-overlapping channels (block 620). The process 600 may determine that all the non-overlapping channels (such as channel 1, 6, and 11 in the 2.4 GHz band) may have ongoing transmissions or scheduled traffic. Thus, the process 600 may select an intermediate channel, which refers to gaps between the non-overlapping channels 1, 6, and 11, as the target channel for NB-Assisted UWB ranging.

In more embodiments, the process 600 may execute, based on the selected target channel, an NB signaling that transmits a data packet via an NB signal (block 640). The process 600 may transmit the NB signal data packet to coordinate and synchronize between transmission and reception devices, for example, an AP and peer APs, user devices, Internet-of-Things (IoT) devices, or the like, respectively. In additional embodiments, the data packet may be configured to indicate a time period for reception of a plurality of fragments during the ranging round.

In further embodiments, the process 600 may execute, based on an UWB, a UWB signaling that transmits at least one fragment of the plurality of fragments via a UWB signal (block 650). The process 600 may utilize the time period indicated by the NB signal data packet to execute the UWB ranging using the UWB signaling. The UWB signaling may include at least one fragment of the plurality of fragments as a UWB signal pulse. In an example scenario, an AP, located in a conference room, may transmit a UWB signal in the time period indicated by the NB signal data packet to a user device (such as a smartphone). The user device may receive the UWB signal and may respond by sending a UWB signal back to the AP. The AP may thus calculate the ToF based on the round-trip time of the UWB signal and estimate the distance between the AP and the user device. Thus, the AP may trigger specific actions, like adjusting the lighting of the conference room based on the specific location of the user device.

However, if the one or more neighboring devices do not utilize a plurality of non-overlapping channels, in still more embodiments, the process 600 may select the target channel from a set of available channels (block 630). The channel status message, as received by the process 600, may include information such as channels associated with the one or more neighboring devices (such as one or more nearby APs) and the channel metric associated with these channels. Thus, the process 600 may determine which channels from among the set of available channels can be utilized for ranging round. In still further embodiments, the process 600 may select the target channel from the set of available channels based on at least one of an RSSI value, a scheduled amount of traffic, or an amount of traffic buffered to at least one priority queue associated with the channel. In still additional embodiments, the process 600 may execute, based on the selected target channel, the NB signaling that transmits a data packet via an NB signal (block 640) followed by the UWB signaling that transmits the at least one fragment of the plurality of fragments via the UWB signal (block 650).

Although a specific embodiment for channel selection used for ranging measurements suitable for carrying out the various steps, processes, methods, and operations described herein is discussed with respect to FIG. 6, any of a variety of systems and/or processes may be utilized in accordance with embodiments of the disclosure. In numerous embodiments, the process 600 may select a local channel for a current AP as the target channel to be utilized for ranging measurements. The current AP may be far away from other neighboring devices (such as one or more APs), and thus, the likelihood of interference with the selected target channel may be minimized. The elements depicted in FIG. 6 may also be interchangeable with other elements of FIGS. 1-5 and 7-10 as required to realize a particularly desired embodiment.

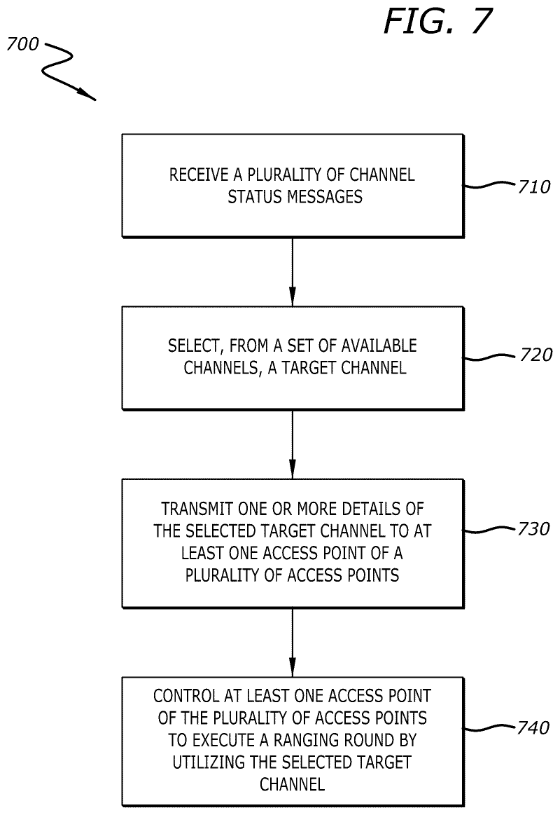

Referring to FIG. 7, a flowchart showing a process 700 using a wireless controller for channel selection used for ranging in accordance with various embodiments of the disclosure is shown. In many embodiments, the process 700 may receive a plurality of channel status messages (block 710). The process 700 may receive the plurality of channel status messages from a plurality of APs operating in a network. In an example scenario, the process 700 may be executed by a wireless controller (WLC) that manages, configures, controls, and coordinates the APs located in a wireless local area network (WLAN), such as an enterprise network, university campus, technology conference, or the like. The WLC may be configured to provide a centralized management of all the APs, dynamic channel assignment to the APs to minimize interference, power management, load balancing, seamless roaming, and other such management/coordination functions. In a number of embodiments, the process 700 may receive the plurality of channel status messages at regular intervals from the plurality of APs. The channel status messages may be used for Radio Resource Management (RRM) and provide information about the quality and conditions of the wireless channel, such as interference levels, RSSI, noise, and channel utilization.

In a variety of embodiments, the process 700 may select, from a set of available channels, a target channel (block 720). Each channel status message received by the process 700 may indicate a channel associated with one of the plurality of APs and a channel metric associated with the channel. The channel metric may indicate one or more of an RSSI value associated with the channel, a scheduled amount of traffic associated with the channel, or an amount of traffic buffered to at least one priority queue of the channel. Based on the information received in the channel status messages, the process 700 may thus, determine the set of available channels that can be utilized as the target channel for ranging round. The process 700 thus selects the target channel based on the indicated channel metric in each of the plurality of channel status messages. In an example scenario, considering the non-overlapping channels 1, 6, and 11 for Wi-Fi 2.4 GHZ, channel 1 may have a scheduled amount of traffic, buffered video streaming data, and web browsing data from nearby APs, channel 6 may have a buffered video streaming traffic in priority queue, and channel 11 may only have non-urgent background traffic from nearby APs. Thus, based on the amount of traffic on each channel, the process 700 may select channel 11 as the target channel.

In more embodiments, the process 700 may transmit one or more details of the selected target channel to at least one AP of the plurality of access points (block 730). Continuing with the example above, based on the selection of channel 11, the process 700 may transmit information regarding the availability of the channel 11 for ranging round to at least one AP of the plurality of access points.

In additional embodiments, the process 700 may control the at least one AP of the plurality of APs to execute a ranging round by utilizing the selected target channel (block 740). In additional embodiments, the process 700 may control the at least one AP of the plurality of APs to transmit a null data frame for a specific time duration on a specific channel among the set of available channels. The specific channel among the set of available channels may be the selected target channel for the specific time duration. The null data frame may be transmitted by the at least one AP of the plurality of APs to indicate that no data may be transmitted during the specific time duration on the selected target channel. The null data frame does not carry data and may serve as a signal to prepare for further communication. In further embodiments, the process 700 may control the at least one AP of the plurality of APs to transmit an NB signal data packet flow, utilizing the selected target channel, for subsequent ranging round.

Although a specific embodiment for a wireless controller used for channel selection for ranging suitable for carrying out the various steps, processes, methods, and operations described herein is discussed with respect to FIG. 7, any of a variety of systems and/or processes may be utilized in accordance with embodiments of the disclosure. In numerous embodiments, the process 700 may control the at least one AP of the plurality of APs to transmit a null data frame to indicate a change in the power state of the at least one AP. For example, the at least one AP may indicate to a receiving device regarding exiting a low-power mode and to prepare for further communication. The elements depicted in FIG. 7 may also be interchangeable with other elements of FIGS. 1-6 and 8-10 as required to realize a particularly desired embodiment.

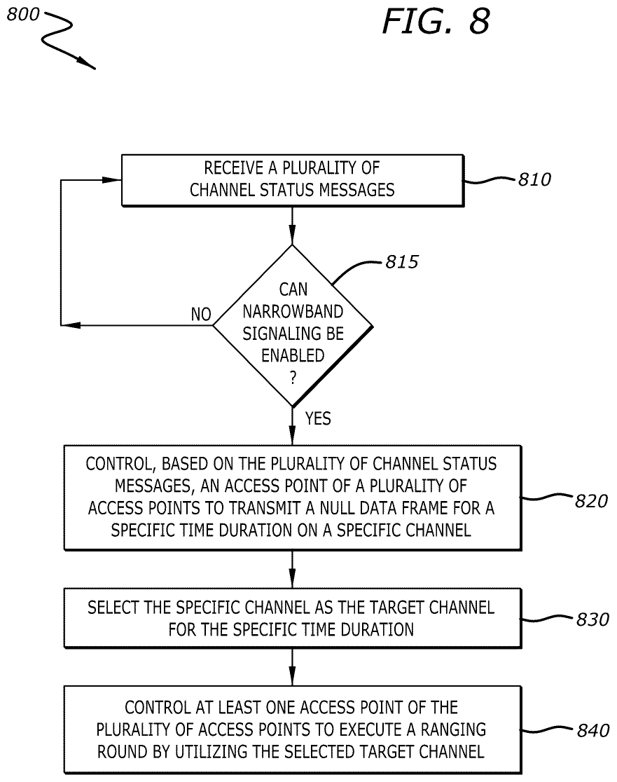

Referring to FIG. 8, a flowchart showing a process 800 for channel selection by a wireless controller for NB-Assisted UWB ranging in accordance with various embodiments of the disclosure is shown. In many embodiments, the process 800 may receive a plurality of channel status messages (block 810). The process 800 may receive the plurality of channel status messages from a plurality of APs operating in a network controlled by the wireless controller. Each channel status message may indicate a channel associated with one of the plurality of APs and a channel metric associated with the channel. The channel metric may indicate one or more of an RSSI value associated with the channel, a scheduled amount of traffic associated with the channel, or an amount of traffic buffered to at least one priority queue of the channel.

In a number of embodiments, the process 800 may determine whether narrowband signaling can be enabled (block 815). 802.15.4ab standard for UWB technology also envisions a Multi-Millisecond (MMS) feature. MMS mechanism in UWB ranging may refer to a technique that extends the duration of ranging measurements to multi-millisecond time intervals. The MMS-UWB ranging may not inherently require NB signaling. However, the 802.15.4ab standard merely allows both modes (with and without NB signaling), without differentiating the scenarios where one or the other should be used. In a variety of embodiments, the process 800 may determine the usage of NB signaling based on the density of the network. In an example scenario, if the utilization of Wi-Fi network in 2.4 GHz band is high, thus indicating that all candidate channels are being utilized by at least one AP, and heard above a configurable threshold by any other AP in the network. In such a scenario, the NB signaling may be disabled, thus providing an interference free Wi-Fi operation. However, when the throughput of Wi-Fi in 2.4 GHz band is not a priority, and fast as well as accurate ranging may be required, the NB signaling may be enabled.

If the narrowband signaling cannot be enabled, in yet more embodiments, the process 800 may continue to receive the plurality of channel status messages (block 810). The process 800 may receive the plurality of channel status messages at a regular interval from the plurality of APs. However, if the narrowband signaling can be enabled, in more embodiments, the process 800 may control, based on the plurality of channel status messages, an AP of the plurality of APs to transmit a null data frame for a specific time duration on a specific channel (block 820). The null data frame may be transmitted by the at least one AP of the plurality of APs to indicate that no data may be transmitted during the specific time duration.

In additional embodiments, the process 800 may select the specific channel as the target channel for the specific time duration (block 830). The process 800 may select the specific channel among the set of available channels as the target channel to be utilized for ranging round. The specific channel may be selected as the target channel based on the information indicated by the plurality of channel status messages. In further embodiments, the process 800 may select a channel associated with the lowest RSSI value, a channel associated with the lowest scheduled amount of traffic, or a channel associated with the lowest amount of traffic buffered to at least one priority queue as per the channel status messages as the target channel.

In still further embodiments, the process 800 may control at least one AP of the plurality of APs to execute a ranging round by utilizing the selected target channel (block 840). For example, the process 800 may transmit a message to the at least one AP to indicate the selected target channel. Thus, the process 800 may control the at least one AP to transmit an NB signal data packet indicating a time period for reception UWB signal during the ranging round. Further, the process 800 may control the at least one AP to utilize the time period indicated by the NB signal data packet to execute the UWB signaling and perform ranging measurements. In several embodiments, the process 800 may transmit the message to the plurality of APs to indicate the selected target channel to allow the plurality of APs to commonly utilize the selected target channel for executing corresponding ranging rounds.

Although a specific embodiment depicting a wireless controller for channel selection used for ranging suitable for carrying out the various steps, processes, methods, and operations described herein is discussed with respect to FIG. 8, any of a variety of systems and/or processes may be utilized in accordance with embodiments of the disclosure. In still yet more embodiments, the process 800 when implemented in, for example, Wi-Fi 5 GHz band, only 20 MHz channels may be assigned while avoiding the 40 MHz channels to minimize interference with Wi-Fi operations. The elements depicted in FIG. 8 may also be interchangeable with other elements of FIGS. 1-7 and 9-10 as required to realize a particularly desired embodiment.

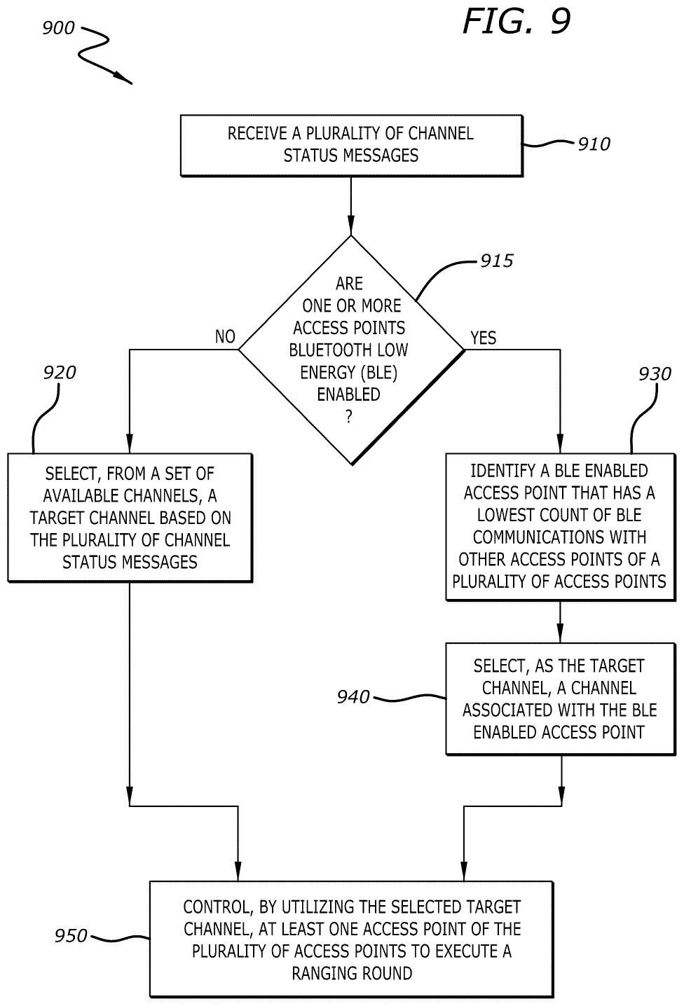

Referring to FIG. 9, a flowchart showing a process 900 for NB-Assisted UWB ranging in a BLE coexistence scenario in accordance with various embodiments of the disclosure is shown. In many embodiments, the process 900 may receive a plurality of channel status messages (block 910). The process 900 may receive the plurality of channel status messages from one or more APs operating in a network. Each channel status message may indicate a channel associated with one of the one or more APs and a channel metric associated with the channel.

In a number of embodiments, the process 900 may determine whether the one or more APs are BLE enabled (block 915). In many scenarios, the APs may have dual functionality and can provide both Wi-Fi and BLE connectivity. If the process 900 determines that the one or more APs are BLE enabled, in a variety of embodiments, the process 900 may identify a BLE enabled AP that has the lowest count of BLE communications with other APs of a plurality of APs (block 930). The process 900 may monitor a set of channels utilized by the one or more APs based on the plurality of channel status messages. Since the range of the BLE communication is smaller than the Wi-Fi communication, the process 900 may select an AP having the lowest count of BLE communications (such as pairing and data exchange). The process 900 may thus select the AP as source for NB-Assisted UWB ranging.

In more embodiments, the process 900 may select, as the target channel, a channel associated with the BLE enabled AP (block 940). The process 900 may select the target channel as a channel associated with the BLE enabled AP as the AP may have BLE channels on which no active communication is happening. In additional embodiments, the process 900 may control, by utilizing the selected target channel, at least one AP of the plurality of APs to execute a ranging round (block 950). The process 900 may thus control the at least one AP to perform an NB signaling utilizing the selected target channel, and subsequently perform the UWB ranging.

If, however, it may be determined that the one or more APs are not BLE enabled, in further embodiments, the process 900 may select, from a set of available channels, a target channel based on the plurality of channel status messages (block 920). In still more embodiments, the process 900 may control, by utilizing the selected target channel, at least one AP of the plurality of APs to execute a ranging round (block 950). For example, the process 900 may transmit a message to the at least one AP to indicate the selected channel.

Although a specific embodiment depicting process 900 for ranging measurements using BLE suitable for carrying out the various steps, processes, methods, and operations described herein is discussed with respect to FIG. 9, any of a variety of systems and/or processes may be utilized in accordance with embodiments of the disclosure. In numerous embodiments, the process 900 may determine that all 3 BLE announcement channels (Channel 37, 38, and 39 in the 2.4 GHz band) may be utilized on all BLE-enabled APs, and thus, these channels can be discarded as NB candidates. These 3 BLE announcement channels may be utilized to minimize the interference with Wi-Fi channels. The elements depicted in FIG. 9 may also be interchangeable with other elements of FIGS. 1-8 and 10 as required to realize a particularly desired embodiment.

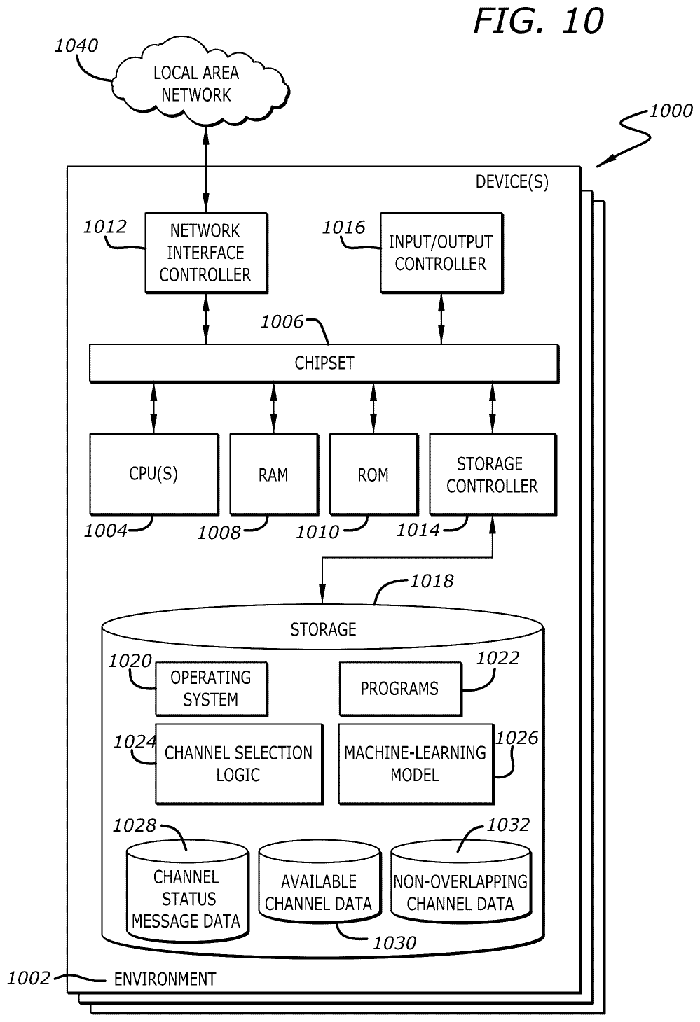

Referring to FIG. 10, a conceptual block diagram for one or more devices 1000 capable of executing components and logic for implementing the functionality and embodiments described above is shown. The embodiment of the conceptual block diagram depicted in FIG. 10 can illustrate a conventional server computer, workstation, desktop computer, laptop, tablet, network appliance, e-reader, smartphone, or other computing device, and can be utilized to execute any of the application and/or logic components presented herein. The device 1000 may, in some examples, correspond to physical devices or to virtual resources described herein.

In many embodiments, the device 1000 may include an environment 1002 such as a baseboard or “motherboard,” in physical embodiments that can be configured as a printed circuit board with a multitude of components or devices connected by way of a system bus or other electrical communication paths. Conceptually, in virtualized embodiments, the environment 1002 may be a virtual environment that encompasses and executes the remaining components and resources of the device 1000. In more embodiments, one or more processors 1004, such as, but not limited to, central processing units (“CPUs”) can be configured to operate in conjunction with a chipset 1006. The processor(s) 1004 can be standard programmable CPUs that perform arithmetic and logical operations necessary for the operation of the device 1000.

In additional embodiments, the processor(s) 1004 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In certain embodiments, the chipset 1006 may provide an interface between the processor(s) 1004 and the remainder of the components and devices within the environment 1002. The chipset 1006 can provide an interface to a random-access memory (“RAM”) 1008, which can be used as the main memory in the device 1000 in some embodiments. The chipset 1006 can further be configured to provide an interface to a computer-readable storage medium such as a read-only memory (“ROM”) 1010 or non-volatile RAM (“NVRAM”) for storing basic routines that can help with various tasks such as, but not limited to, starting up the device 1000 and/or transferring information between the various components and devices. The ROM 1010 or NVRAM can also store other application components necessary for the operation of the device 1000 in accordance with various embodiments described herein.

Different embodiments of the device 1000 can be configured to operate in a networked environment using logical connections to remote computing devices and computer systems through a network, such as the network 1040. The chipset 1006 can include functionality for providing network connectivity through a network interface card (“NIC”) 1012, which may comprise a gigabit Ethernet adapter or similar component. The NIC 1012 can be capable of connecting the device 1000 to other devices over the network 1040. It is contemplated that multiple NICs 1012 may be present in the device 1000, connecting the device to other types of networks and remote systems.

In further embodiments, the device 1000 can be connected to a storage 1018 that provides non-volatile storage for data accessible by the device 1000. The storage 1018 can, for example, store an operating system 1020, applications 1022, and data 1028, 1030, 1032, which are described in greater detail below. The storage 1018 can be connected to the environment 1002 through a storage controller 1014 connected to the chipset 1006. In certain embodiments, the storage 1018 can consist of one or more physical storage units. The storage controller 1014 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1000 can store data within the storage 1018 by transforming the physical state of the physical storage units to reflect the information being stored. The specific transformation of physical state can depend on various factors. Examples of such factors can include, but are not limited to, the technology used to implement the physical storage units, whether the storage 1018 is characterized as primary or secondary storage, and the like.

For example, the device 1000 can store information within the storage 1018 by issuing instructions through the storage controller 1014 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1000 can further read or access information from the storage 1018 by detecting the physical states or characteristics of one or more particular locations within the physical storage units.

In addition to the storage 1018 described above, the device 1000 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1000. In some examples, the operations performed by a cloud computing network, and or any components included therein, may be supported by one or more devices similar to device 1000. Stated otherwise, some or all of the operations performed by the cloud computing network, and or any components included therein, may be performed by one or more devices 1000 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1018 can store an operating system 1020 utilized to control the operation of the device 1000. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1018 can store other system or application programs and data utilized by the device 1000.

In various embodiment, the storage 1018 or other computer-readable storage media is encoded with computer-executable instructions which, when loaded into the device 1000, may transform it from a general-purpose computing system into a special-purpose computer capable of implementing the embodiments described herein. These computer-executable instructions may be stored as application 1022 and transform the device 1000 by specifying how the processor(s) 1004 can transition between states, as described above. In some embodiments, the device 1000 has access to computer-readable storage media storing computer-executable instructions which, when executed by the device 1000, perform the various processes described above with regard to FIGS. 1-9. In more embodiments, the device 1000 can also include computer-readable storage media having instructions stored thereupon for performing any of the other computer-implemented operations described herein.

In still further embodiments, the device 1000 can also include one or more input/output controllers 1016 for receiving and processing input from a number of input devices, such as a keyboard, a mouse, a touchpad, a touch screen, an electronic stylus, or other type of input device. Similarly, an input/output controller 1016 can be configured to provide output to a display, such as a computer monitor, a flat panel display, a digital projector, a printer, or other type of output device. Those skilled in the art will recognize that the device 1000 might not include all of the components shown in FIG. 10, and can include other components that are not explicitly shown in FIG. 10, or might utilize an architecture completely different than that shown in FIG. 10.

As described above, the device 1000 may support a virtualization layer, such as one or more virtual resources executing on the device 1000. In some examples, the virtualization layer may be supported by a hypervisor that provides one or more virtual machines running on the device 1000 to perform functions described herein. The virtualization layer may generally support a virtual resource that performs at least a portion of the techniques described herein.

In many embodiments, the device 1000 can include a channel selection logic 1024 that can be configured to perform one or more of the various steps, processes, operations, and/or other methods that are described above. Often, the channel selection logic 1024 can be a set of instructions stored within a non-volatile memory that, when executed by the processor(s)/controller(s) 1004 can carry out these steps, etc. In some embodiments, the channel selection logic 1024 may be a client application that resides on a network-connected device, such as, but not limited to, a server, switch, personal or mobile computing device, an access point (AP). In certain embodiments, the channel selection logic 1024 can enable the selection of a target channel from a set of available channels to be utilized for executing a ranging round.

In several embodiments, the channel selection logic 1024 can enable the device 1000 (for example, an AP, a wireless controller) to receive one or more channel status messages from neighboring devices. The channel selection logic 1024 may enable the device 1000 to select a target channel from a set of available channels based on the information indicated by the one or more channel status messages. The channel selection logic 1024 may be configured to select the target channel, to be utilized for ranging round, as having the lowest RSSI value, the lowest scheduled amount of traffic, or the lowest amount of traffic buffered to at least one priority queue from among the set of available channels.

In a number of embodiments, the storage 1018 can include channel status message data 1028. In some embodiments, channel status message data 1028 can include information such as a channel associated with a particular network device (for example, an AP) and a channel metric associated with the channel. The channel metric can further include information regarding the quality and conditions of the channel, such as an RSSI value, interference levels, noise, channel utilization, or the like.

In various embodiments, the storage 1018 can include available channel data 1030. The available channel data 1030 can comprise information regarding one or more channels that can be utilized as the target channel for ranging rounds. In additional embodiments, the available channel data 1030 may consider the traffic on the channel, including traffic from Wi-Fi devices, interference from other networks, and non-Wi-Fi devices (e.g., Bluetooth, microwaves). In numerous embodiments, available channel data 1030 may indicate a channel utilization factor, for example, channel 1 of Wi-Fi 2.4 GHz can have buffered traffic to at least one priority queue of the channel, additional heavy traffic related to video calls, file sharing, streaming data, or the like. Thus, this may indicate a high utilization factor for the channel 1. In another scenario, channel 6 of Wi-Fi 2.4 GHz may only be serving web-browsing or non-urgent background traffic of nearby APs. Thus, channel 6 may indicate a low utilization factor, and may be available to be utilized as the target channel.

In still more embodiments, the storage 1018 can include non-overlapping channel data 1032. Non-overlapping channel data 1032 may comprise information regarding the specific channels that do not interfere with each other, as the frequency ranges of these channels do not overlap. For example, in Wi-Fi 2.4 GHz band, channels 1, 6, and 11 are non-overlapping channels.

Finally, in many embodiments, data may be processed into a format usable by a machine-learning model 1026 (e.g., feature vectors), and or other pre-processing techniques. The machine-learning (“ML”) model 1026 may be any type of ML model, such as supervised models, reinforcement models, and/or unsupervised models. The ML model 1026 may include one or more of linear regression models, logistic regression models, decision trees, Naïve Bayes models, neural networks, k-means cluster models, random forest models, and/or other types of ML models 1026. The ML model 1026 may be configured to learn specific traffic pattern with respect to different devices (for example APs) in the environment 1002. Thus, the ML model 1026 may be able to predict a target channel to be utilized for executing a ranging round based on the learned traffic pattern.

The ML model(s) 1026 can be configured to generate inferences to make predictions or draw conclusions from data. An inference can be considered the output of a process of applying a model to new data. This can occur by learning from channel status message data 1028, available channel data 1030, and/or non-overlapping channel data 1032 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1026 may be generated by human/administrator verifications or may compare predicted outcomes with actual outcomes.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A network device, comprising:
a processor; and
a memory communicatively coupled to the processor, wherein the memory comprises a channel selection logic that is configured to:
receive one or more channel status messages, wherein a channel status message of the one or more channel status messages is configured to indicate a channel associated with a neighboring device of the network device and a channel metric associated with the channel;
select, from a set of available channels, a target channel based on the one or more channel status messages; and
execute a ranging round by utilizing the selected target channel.

2. The network device of claim 1, wherein to select the target channel, the channel selection logic is further configured to identify, based on the one or more channel status messages, a channel associated with a lowest channel metric among the set of available channels, and wherein the channel associated with the lowest channel metric is selected as the target channel.

3. The network device of claim 1, wherein the selected target channel is commonly utilized by the network device and the neighboring device to execute corresponding ranging rounds.

4. The network device of claim 1, wherein the target channel utilized by the network device to execute the ranging round is different from a channel utilized by the neighboring device to execute one or more ranging rounds.

5. The network device of claim 1, wherein an interference exhibited by the selected target channel in one or more Wi-Fi operations of the network device and the neighboring device is less than a threshold value.

6. The network device of claim 1, wherein the channel metric corresponds to a Received Signal Strength Indicator (RSSI) value determined by the neighboring device on the channel for a source device.

7. The network device of claim 6, wherein the source device corresponds to one of the network device or another neighboring device.

8. The network device of claim 6, wherein the channel status message is further configured to indicate a first identifier associated with the neighboring device and a second identifier associated with the source device.

9. The network device of claim 1, wherein to select the target channel, the channel selection logic is further configured to:
determine, based on the one or more channel status messages, that one or more neighboring devices of the network device are utilizing a plurality of non-overlapping channels; and
select, as the target channel, at least one intermediate channel between two adjacent non-overlapping channels of the plurality of non-overlapping channels.

10. The network device of claim 1, wherein the ranging round corresponds to a Narrowband-Assisted Ultra-Wideband (NBA-UWB) ranging round.

11. The network device of claim 10, wherein to execute the NBA-UWB ranging round, the channel selection logic is further configured to:
execute, based on the selected target channel, a Narrowband (NB) signaling that transmits a data packet via an NB signal, wherein the data packet is configured to indicate a time period for reception of a plurality of fragments; and
execute, based on an Ultra-Wideband (UWB), a UWB signaling that transmits at least one fragment of the plurality of fragments via a UWB signal.

12. The network device of claim 11, further comprising:
a first communication interface configured to operate on one or more channels of the set of available channels; and
a second communication interface configured to operate on the UWB.

13. The network device of claim 1, wherein the network device corresponds to a wireless access point.

14. The network device of claim 13, wherein the neighboring device corresponds to another wireless access point deployed within a communication range of the network device.

15. A network device, comprising:
a processor;
a network interface controller configured to provide access to a network comprising a plurality of access points; and
a memory communicatively coupled to the processor, wherein the memory comprises a channel selection logic that is configured to:
receive a plurality of channel status messages, wherein a channel status message of the plurality of channel status messages is configured to indicate a channel associated with one of the plurality of access points and a channel metric associated with the channel;
select, from a set of available channels, a target channel based on the plurality of channel status messages; and
control at least one access point of the plurality of access points to execute a ranging round by utilizing the selected target channel.

16. The network device of claim 15, wherein the channel metric is configured to indicate one or more of:
a Received Signal Strength Indicator (RSSI) value associated with the channel,
a scheduled amount of traffic associated with the channel, or
an amount of traffic buffered to at least one priority queue of the channel.

17. The network device of claim 16, wherein the channel selection logic is further configured to select, as the target channel, one of:
a channel associated with a lowest RSSI value among the set of available channels,
a channel associated with a lowest scheduled amount of traffic among the set of available channels, or
a channel associated with a lowest amount of traffic buffered to at least one priority queue among the set of available channels.

18. The network device of claim 15, wherein to select the target channel, the channel selection logic is further configured to control, based on the plurality of channel status messages, an access point of the plurality of access points to transmit a null data frame for a specific time duration on a specific channel among the set of available channels, and wherein the specific channel is selected as the target channel for the specific time duration.

19. The network device of claim 15, wherein the network device corresponds to a Wireless Network Controller.

20. A method, comprising:
in a network device:
receiving one or more channel status messages, wherein a channel status message of the one or more channel status messages is configured to indicate a channel associated with a neighboring device of the network device and a channel metric associated with the channel;
selecting, from a set of available channels, a target channel based on the one or more channel status messages; and
executing a ranging round by utilizing the selected target channel.
